(19) United States
(12) Patent Application Publication
(10) Pub. No.: US 2007/0054622 A1
(43) Pub. Date: Mar. 8, 2007

(54) Hybrid power line wireless communication system

(76) Inventor: William H. Berkman, New York, NY (US)

Correspondence Address: CAPITAL LEGAL GROUP, LLC, 5323 POOKS HILL ROAD, BETHESDA, MD, 20814, US

(21) Appl. No.: 11/217,392

(22) Filed: Sep. 2, 2005

(51) Int. Cl. H04B 17/00

(52) U.S. Cl. 455/67.11; 455/67.13

(57) ABSTRACT

In a hybrid communication system a wireless communication link is maintained between a power line communication medium and a non-power line communication medium. Wireless communication is established within an unlicensed frequency band and monitored for quality. If the quality falls below a threshold, a wireless communication link is established within a licensed frequency band. The wireless link may be maintained between a power line communication system (PLCS) backhaul point and an internet protocol (IP) network access point, and/or between a PLCS endpoint communication interface and a premises communication device.

### FIELD OF THE INVENTION

The present invention generally relates to methods and systems of power line communication, and more particularly to interfacing power line communications and wireless communications.

### BACKGROUND OF THE INVENTION

A power line communication system (PLCS) uses the infrastructure of existing power distributions systems to form a communication network. Well-established power distribution systems exist throughout most of the United States, and other countries providing power to customers via power lines. With some modification, the infrastructure of the existing power distribution system can be used to provide data communication, in addition to conventional power delivery. In other words, existing power lines that already have been run to many homes and offices can be used to carry data signals to and from those homes and offices. These data signals are communicated on and off the power lines at various points in the power line communication system, such as, for example, near homes, offices, IP network service providers, and the like.

To implement a PLCS that can tie into a global information network, such as the internet, an interface is needed between the PLCS and the conventional telecommunications network, (e.g., a point of presence (POP) for the internet). Another interface is needed to between the power lines and end user devices.

With regard to an interface with the conventional telecommunication network, an example PLCS includes a backhaul point. The backhaul point serves as a gateway between the power line and the conventional telecommunications network. In one direction, the backhaul point receives communication signals from the conventional telecommunications network, and forwards the communications to a plurality of downstream devices in the PLCS, such as transformer bypass devices. In the other direction, the backhaul point receives signals from the downstream devices in the PLCS and forwards the communications to the conventional telecommunication medium.

One known manner of coupling the backhaul point to the conventional telecommunications network includes a fiber optic cable. When fiber optic cable is not available at the backhaul point location, additional fiber optic cable generally is installed. However, in some instances it may not be feasible or possible to install fiber optic cable to connect the backhaul point to the conventional telecommunications network. For example, installing additional fiber optic cable can be cost prohibitive. In another example, existing infrastructure such as intersections and other obstacles may not allow additional fiber optic cable to be installed. Another known method of coupling a backhaul point to the conventional telecommunications network is by using a wireless link. However, unlicensed wireless links are often not reliable and licensed wireless links are often very expensive

Consequently, there is a need for technology to provide a communications link that communicatively couples a PLCS (such as one or more backhaul points) to a conventional telecommunications network in an economical, easy to implement manner providing high bandwidth, low latency, and system reliability.

With regard to link with end user devices, an example PLCS may include a modem and a data router located at a distribution transformer. The data router routes data to and from low voltage premise networks and/or other last leg links coupled to end user devices. The power distribution transformer typically serves one to ten homes in a conventional North American power distribution system. Accordingly, the data router may serve all end user devices being coupled into the PLCS for all of those one to ten homes subscribing to use the PLCS. In the conventional PLCS, the router can become a bottleneck as many end user devices vie for access to the router for sending and receiving communications over the PLCS.

Consequently, there is a need for technology to provide a communications link that communicatively couples a power line communications device (such as one or more bypass devices) to multiple end user devices in an economical, easy to implement manner providing high bandwidth, low latency, and system reliability.

Embodiments of the present invention address these needs offering advantages over conventional PLCS systems.

### SUMMARY OF THE INVENTION

The present invention is directed to a hybrid power line wireless communication system and a method of wireless communication.

According to one aspect of the invention, a first wireless communication link is established using an unlicensed frequency band. The quality of the first wireless communication link is assessed. When the assessment indicates that the link is below a predetermined quality, a second wireless communication link is established using a licensed frequency band. The first link may be terminated after the second link is established.

In one example embodiment, the system includes a communication node having a wireless communication link and a power line communication link. A communication is received at the communication node from either one of the wireless communication link or the power line communication link, then forwarded along the other one of the wireless communication link and the power line communication link. The wireless link may use a licensed or unlicensed frequency band depending on the quality of unlicensed link.

In one implementation, the wireless communication link carries communications between an access point of an external network and the power line communication node in either direction. In another implementation, the wireless communication link carries communications between a user device and the communication node in either direction. The power line communication link may forward the communication within the power line portion of the hybrid communication system.

One advantage of some embodiments of this invention is that system capacity is increased by using both a wireless link and a wired link, which may be a power line link, fiber optic link, coaxial cable link, and/or twisted pair link. Another advantage is that latency may be reduced among nearby end users accessing the network. These and other aspects and advantages of the invention will be better understood by reference to the following detailed description taken in conjunction with the accompanying drawings.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a diagram of an exemplary overhead power distribution system;

FIG. 2 is a block diagram of a power line communication system;

FIG. 3 is a block diagram of a hybrid communications sub-network according to an embodiment of this invention;

FIG. 4 is a flow chart of a method for establishing a communication link according to an embodiment of this invention;

FIG. 5 is a flow chart of a method for establishing a communication link according to another embodiment of this invention;

FIG. 6 is a block diagram of an example embodiment of a backhaul point that may be used in implementing the present invention; and

FIG. 7 is a block diagram of an example embodiment of a communication interface that may be used to implement the present invention

### DETAILED DESCRIPTION OF ILLUSTRATIVE EMBODIMENTS

In the following description, for purposes of explanation and not limitation, specific details are set forth, such as particular networks, communication systems, computers, PLCS, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, PLCS, terminals, devices, components, techniques, data and network protocols, software products and systems, operating systems, development interfaces, and hardware are omitted so as not to obscure the description of the present invention.

System Architecture and General Design Concepts

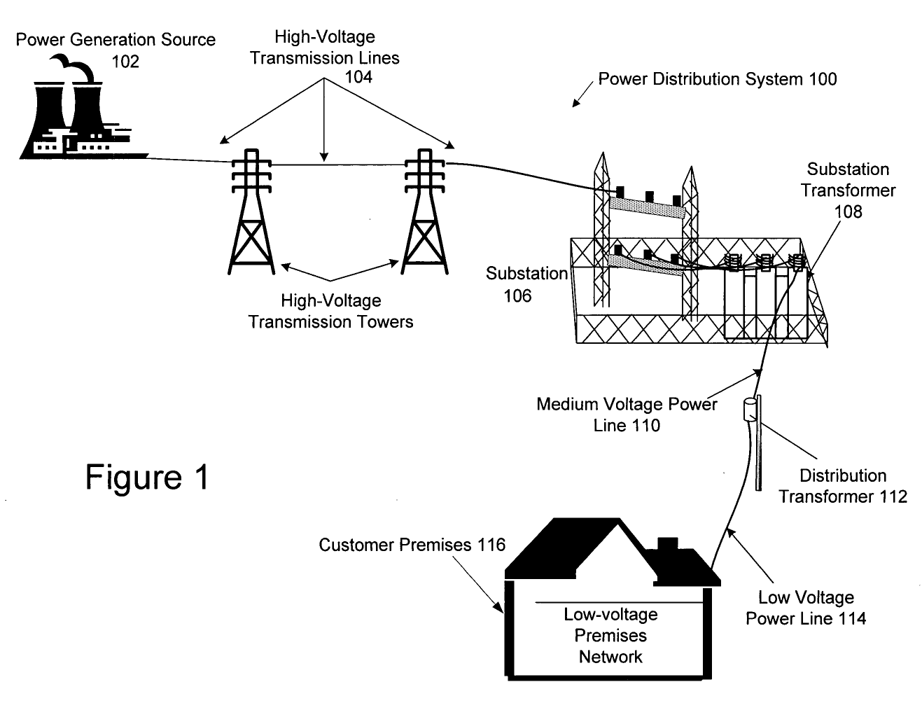

FIG. 1 illustrates an example power distribution system 100 that is part of a power grid infrastructure, including power generation sources, power transmission components, and power distribution components. Power is generated at a power generation source 102, which typically generates power as high as 25 kilo-volts (kV). A transmission substation (not shown), typically located near a corresponding power generation source, increases the generated voltage to a desired high voltage for transmission along high voltage (HV) transmission lines 104. Typical voltages found on HV transmission lines 104 range from 69 kV to in excess of 800 kV. Power is transmitted over the power grid along the HV transmission lines 104.

Switching substations (not shown) are located along the grid to route the high voltage power line transmissions from one portion of the power grid to another portion. Distribution substations 106 receive the high voltage power line transmissions and reduce the high level power voltages to medium level power voltages. More specifically, the distribution substation 106 includes a substation transformer 108 which converts the high level power voltages to the medium level power voltages. The substation transformer 108 has a primary side for connection to a first voltage (e.g., a high voltage section) and a secondary side for outputting another voltage (e.g., a medium voltage section). Medium voltage (MV) power lines 110 distribute the medium level power voltages to a region or local area. Typical voltage levels on the MV power lines 108 range from about 1000 V to about 100 kV.

To distribute power at the low level voltages that are required at customer premises 116, the MV power lines 110 extend to multiple distribution transformers 112. A distribution transformer 112 steps down the medium level power voltages to the requisite lower level voltages. The distribution transformers 112 have a primary side for connection to a first voltage (e.g., the medium voltage section) and a secondary side for outputting another voltage (e.g., the low voltage section). The substation transformers 108 and distribution transformers 112 also are referred to as step-down transformers. Low voltage (LV) power lines 114 carry the low level power voltages to households and other types of customer premises 116. Typical voltage levels on LV power lines 110 typically range from about 100 V to about 240 V.

Distribution transformers 112 distribute low level power signals to the end user facilities as one, two, three, or more phased power signals, depending upon the demands of the end user. In the United States, for example, the local distribution transformers typically feed anywhere from one to ten homes, depending upon the concentration of the customer premises in a particular area. In Europe the medium level voltages and low level voltages typically are higher than those used in the United States and Canada. As a result, the distribution transformers included in the European power grid infrastructure typically serve an entire neighborhood. In various embodiments distribution transformers are pole-top transformers located on a utility pole, pad-mounted transformers located on the ground, or transformers located under ground level.

Power Line Communication System

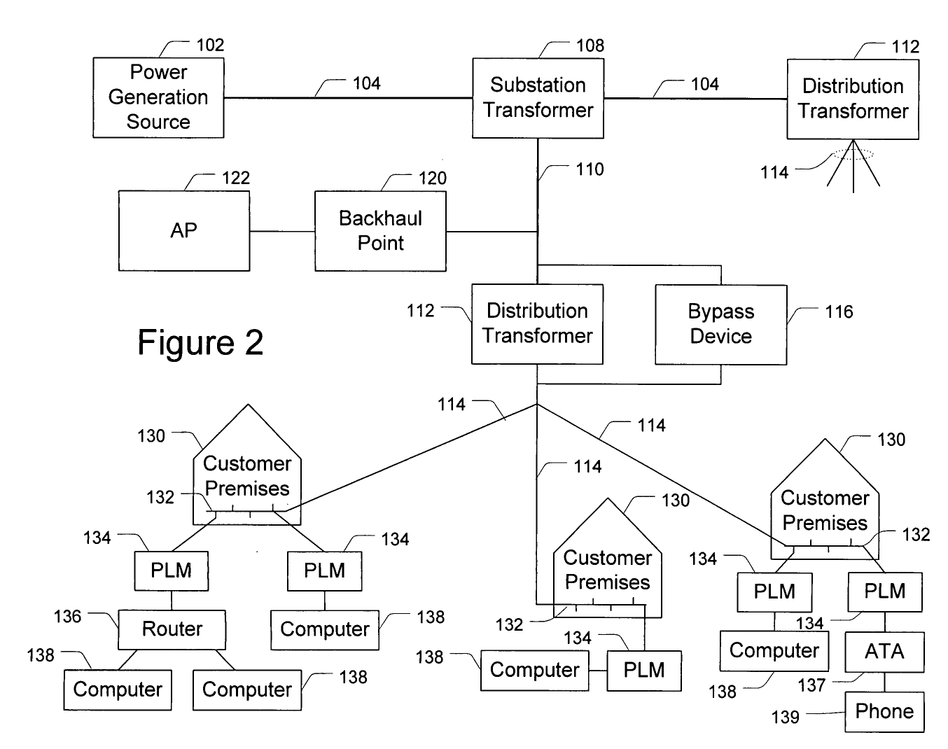

An example of one portion of an overhead power line communication system (PLCS) is shown in FIG. 2, including one or more communications devices, which may be transformer bypass devices. In this illustration, only one communications device (bypass device 116) is depicted. However, in practice five, ten, or more communications devices may form part of a single PLCS subnet. The communications device (e.g., bypass device 116) is the gateway between an LV power line subnet (i.e., the LV power lines 114 and the devices that are communicatively coupled to the LV power lines) and the MV power line 110. The bypass device 116 provides communications services to user devices, (e.g., routers 136, computers 138, telephone adapters 137 and phones 139) and other types of user devices).

In this example PLCS, the PLCS subnet also includes a backhaul point 120. The backhaul point 120 is an interface and gateway between the power line and a non-power line telecommunications network. One or more backhaul points 120 typically are communicatively coupled to an aggregation point (AP) 122 that may be coupled to (or form part of) a point of presence (POP) to an IP network (e.g., the Internet). The backhaul point 120 may be connected to the AP 122 using any available mechanism.

At the user end of the PLCS, data flow originates from a user device, which provides the data to a power line modem (PLM) 134, which is well-known in the art. Various electrical circuits within the customer's premises distribute power and data signals over a premises power line network 132 within the customer premises. The customer draws power on demand by plugging a device into a power outlet. In a similar manner, the customer may plug the power line modem 134 into a power outlet to digitally connect user devices to communicate data signals carried by the power wiring. The PLM 134 thus serves as an interface for user devices to access the PLCS.

The aggregation point (AP) 122 typically includes an Internet Protocol (IP) network data packet router and is connected to an IP network backbone, thereby providing access to the IP network (and be a POP). Alternatively, the AP 122 may be connected to a POP, which provides access to the IP network, or another communication network. In a preferred embodiment, the backhaul point 120 is coupled to the AP 122 using a wireless communication link as described below according to an example embodiment of the present invention. In alternative embodiments, any of several available coupling media are used to link the backhaul point 120 and the AP 122, including fiber optic conductors, T-carrier, Synchronous Optical Network (SONET), and wireless techniques. A method of establishing the wireless communication link is described above in a separate section, under the heading “Wireless Links.”

In some areas a plurality of aggregation points 122 are connected to a POP which provides access to the IP network. The POP (or AP 122 as the case may be) may be capable of routing voice and general data traffic to and from a particular IP network. The routing of packets is determined by any suitable means such as by including information in the data packets to determine whether a packet is voice. The IP network typically handles voice and data packets differently, so as to meet the latency requirements for voice packets.

Alternatively, the backhaul point 120 communicates with a distribution point (not shown) which routes data among a plurality of additional backhaul points 120.

In yet another embodiment, multiple backhaul points 120 communicate with one aggregation point 122. A plurality of backhaul points 120 may be connected to a distribution point and the distribution points may be coupled to the AP 122, which provides access to the IP network and other networks.

Some embodiments include multiple distribution points, in which a plurality of backhaul points 120 communicate with a given distribution point. A backhaul point 120 can communicate with a distribution point. Each group of distribution points may communicate with a corresponding AP 122.

A detailed description of an example PLCS, its components and features is provided in U.S. patent application Ser. No. 11/091,677 filed Mar. 28,1405, Attorney Docket No. CRNT-0239, entitled “Power Line Repeater System and Method,” which is hereby incorporated by reference in its entirety. A detailed description of another example PLCS, its components and features is provided in U.S. patent application Ser. No. 10/973,493 filed Oct. 26, 1184, Attorney Docket No. CRNT-0229, entitled “Power Line Communications System and Method of Operating the Same,” which is hereby incorporated by reference in its entirety. The present invention may be used with power line communication (PLC) networks as described in the above patent applications. Thus, the invention is not limited to a particular PLCS, PLCS architecture, backhaul link, topology, data types, data services, or application.

Hybrid Communication Sub-network Overview

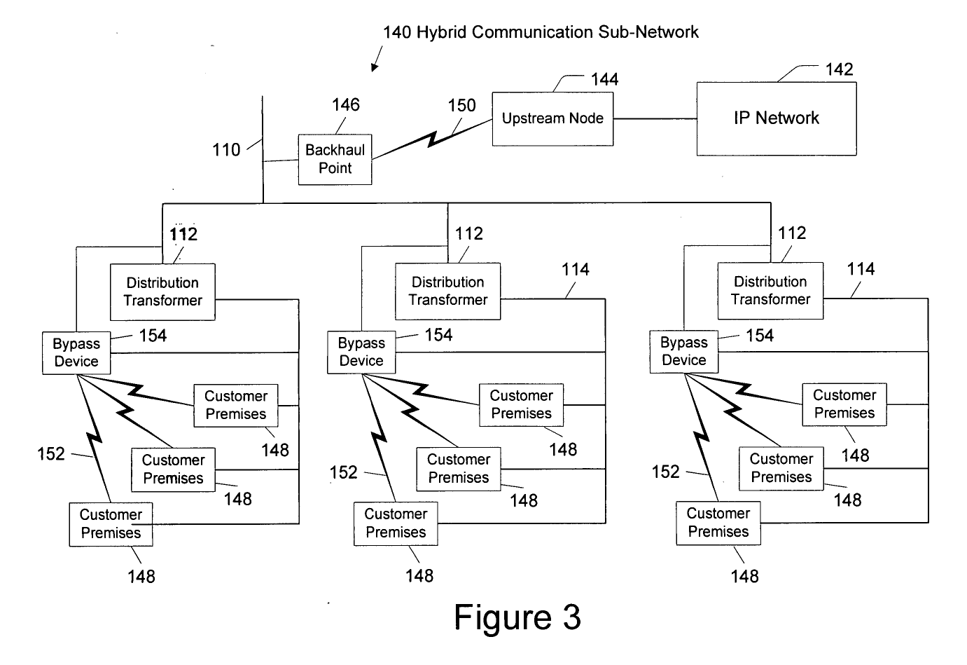

FIG. 3 illustrates an embodiment of a hybrid communication sub-network 140 which links to an IP network 142. The hybrid communication sub-network 140 is formed by a power line communications system (PLCS) having one or more wireless links. A portion of a hybrid power line wireless sub-network 140 is illustrated and includes multiple distribution transformers 112, MV power lines 110, LV power lines 114, and multiple communication links. One type of communication node is a backhaul point 146 which communicates via a wireless link 150 to an uplink node 144. The uplink node may comprise or be coupled to an aggregation point as described above. Another type of communication node is a bypass device 154, which provide a wireless communication link 152 with devices at one or more customer premises 148. For clarity, the term “bypass device” is used herein to refer to a device that may provide communications between the MV power line and one or more user devices, routers, electronic meters or other devices and is not limited to a device that is coupled to both the MV and LV power lines.

Communications within the sub-network 140 travel in both directions between communication nodes, (i.e., backhaul point(s) 146 and bypass devices 154). Information entering the sub-network 140 targeted to a local subscriber may be received at a backhaul point 146, then communicated along the MV power lines 110 to the bypass devices 154. The bypass devices 154 may route the information to all of, or the appropriate, customer premises 148. Information entering the sub-network 140 from a customer premises 148 is received at a bypass device 154 (e.g., via wireless link or wired link), then communicated along the MV power lines 110 to the backhaul point 146 for communication out of the sub-network 140 to the IP network 142.

In the sub-network 140 embodiment illustrated, the bypass device 154 provides communications services for user devices. Exemplary communication services, include: security management; IP network protocol (IP) packet routing; data filtering; access control; service level monitoring; service level management; signal processing; and modulation/demodulation of signals transmitted over the power lines 110.

In one example embodiment, the bypass devices 154 may include a wireless modem to communicate with devices at the customer premises 148 over a wireless communication link 152. In other embodiments other communication media may also be supported, such as the low power line 114, a coaxial cable, a fiber optic cable, a twisted pair (digital subscriber line or DSL), Ethernet or any other suitable link. These connections to the customer premises 148 in turn connect to a user device within the premises, such as a computer or a network. In various embodiments, the customer premises 148 include an LV power line network, a coaxial cable network, an Ethernet network, a wireless network or another type of local area network or wide area network.

Wireless Links

One or more wireless links may be maintained in the hybrid power line wireless sub-network 140. In some embodiments, a wireless link 150 is maintained by a backhaul interface to carry communications between a backhaul point 146 and an uplink node 144 (which may comprise an access point and/or aggregation point) connected to an IP network 142. In some embodiments a wireless link 152 is maintained between one or more user devices and a MV access device (e.g., a transformer bypass device 154).

The wireless links 150,152 may use any suitable frequency band such as the licensed frequency bands (e.g., 6 GHz, 11 GHz, 18 GHz, 23 GHz, 24 GHz, 28 GHz, or 38 GHz band) or unlicensed frequency bands (e.g., 900 MHz, 2.4 GHz, 5.8 Ghz, 24 GHz, 38 GHz, or 60 GHz (i.e., 57-64 GHz)). In some environments, licensed bands may be desirable because they are likely to experience less interference and potentially fewer errors. Other frequencies that may be used may include bands at the 75 GHz and 90 GHz frequencies. In addition, higher frequency bands sometimes equate to smaller antennas and/or other characteristics that may be more suitable for the implementation of the invention than lower frequencies. Thus, in some embodiments, it may desirable to use frequencies that are greater than 2 GHZ, more preferably greater than 5 GHz, still more preferably greater than 22 GHz, and even more preferably greater than 57 GHz.

In one embodiment the wireless links communicate using protocols substantially conforming to the IEEE 802.16 standards (also referred to as WiMAX,), a suite of air interface standards for combined, fixed, portable and mobile broadband wireless access (MBWA) using a point to multi-point architecture. The IEEE 802.16 standards define the use of bandwidth between licensed frequencies between 10 GHz and 66 GHz and between both licensed and unlicensed frequencies between 2 GHz and 11 GHz. A media access control (MAC) layer may support multiple physical layer alternative layers, which may vary according to the frequency band of use.

Underlying the MAC architecture is a physical layer. For the 10-66 GHz support, the physical layer supports line of sight propagation using a single carrier modulation with adaptive burst profiling and access by time division duplexing or frequency division duplexing, although other modulation and access formats are implemented in other embodiments. For the 2-11 GHz support, non-line-of-sight operation may be provided.

In another embodiment the wireless links may use protocols substantially conforming to the multipoint microwave distribution system (MMDS), another wireless broadband technology for IP network access covering licensed frequencies between 2596 MHz and 2644 MHz. MMDS channels may include 6 MHz bands at frequencies licensed exclusively by the Federal Communications Commission. MMDS generally is a line-of-sight service.

In another embodiment, the wireless links communicate using protocols conforming to the IEEE 802.11a standard. As is known to those skilled in the art, the IEEE 802.11a standard includes four channels in three bands. Specifically, it employs channels 36, 40, 44, and 48 in the 5.15 to 5.25 GHz band (“low band”), channels 52, 56, 60 and 65 in the 5.25 to 5.35 GHz band (“mid-band”), and channels 149, 153, 157, and 161 in the 5.725 to 5.825 band (“high band”). The permitted transmission power in the bands is 2.5 mW/MHz in the low band, 12.5 mW/MHz in the mid-band, and 8 mW/MHz in the high band. Thus, in some embodiments, it may be desirable to use the mid-band due to the higher permitted transmission power, which may reduce errors. In other embodiments, it may be desirable to select the band(s) having less interference.

In still another embodiment the wireless links implement wireless DOCSIS (Data Over Cable System Interface Specification) signals (e.g., DOCSIS 1.0, 1.1, or 2.0). Likewise, the signals communicated over the MV power line may be DOCSIS compliant signals (but perhaps in a different frequency than that of the wireless DOCSIS signals), Worldwide Interoperability for Microwave Access (WiMAX), or other OFDM signal set (e.g., a HomePlug frequency shifted to a wireless band).

In other embodiments the hybrid communication sub-network 140 supports wireless links using varying protocols from among the protocols complying with 802.16 standards, 802.11a standards, MMDS and DOCSIS, or other suitable signal set.

Communications over a wireless link 150, 152 can occur using a frequency band licensed from the FCC or using an unlicensed frequency band. Unlicensed bands are often used by home networking devices and can be used by numerous in any given area. Thus, depending on the devices nearby, an unlicensed band may be unsuitable for communications due to substantial data traffic and/or interference or may be suitable (e.g., if there are few devices nearby or few devices nearby that are transmitting data). Licensed bands are generally more predictable (and often have less data traffic and interference), but are often expensive for a PLCS operator to use due to the fact that purchasing such a license is expensive.

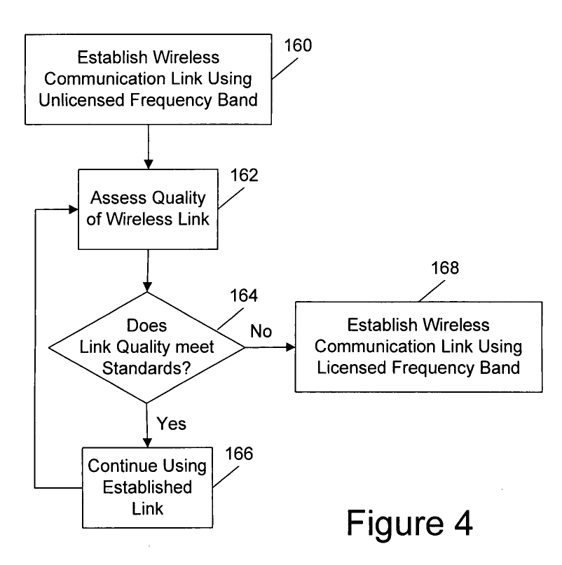

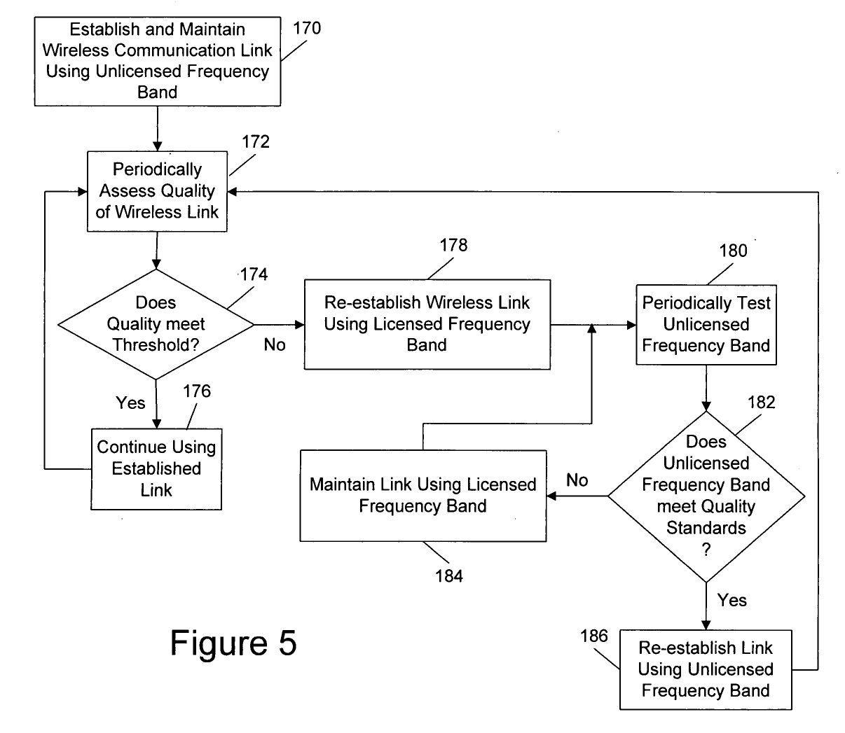

The present invention provides for using an unlicensed frequency band when suitable and switching to a licensed frequency band when the unlicensed band becomes unsuitable. FIG. 4 is a flow chart for a method of establishing a wireless link, which supports switching between licensed and unlicensed frequency channels at a given interface to maintain communications, and manage communication traffic. FIG. 5 is a flow chart for a similar method including additional steps. In example embodiments, an unlicensed frequency band is used when an adequate signal quality is available for that band. By using unlicensed frequency bands, when available, system cost may be reduced.

The illustrated method is one example method for maintaining a wireless link 150 between a backhaul point 146 of the hybrid communication sub-network 140 and an uplink node 144. The illustrated method also is an example method for maintaining a wireless link 152 between a MV access device (e.g., a bypass device 154) and a premises modem. For clarity, and MV access device may include any device physically coupled to a MV power line including but not limited to a backhaul point 146, a bypass device 154, or an MV repeater. One of ordinary skill in the art appreciates that other methods of maintaining a wireless link also may be implemented. Accordingly, the hybrid communication sub-network 140 need not implement the example method at all wireless links 150, 152. The methods described herein may be implemented in computer readable instructions in an encoded medium and executed by a processor in the uplink node, MV user device, backhaul point, and/or premises modem.

Referring to FIG. 4, at step 160, a wireless communication ink 150, 152 is established using an unlicensed frequency band to communicate between a communication node of the hybrid communication sub-network 140 and a remote non-power line communication node (e.g., uplink node 144; premises modem 280). At step 162, the quality of the wireless link is assessed. Step 162 may be performed once, periodically, aperiodically, randomly or at any suitable time or frequency. In one embodiment quality of the link is assessed using a signal to noise ratio (SNR) estimated from communication information (e.g., data communications over the link) such as bit rate, error rate, a combination thereof, or any other suitable method. In other embodiments alternative assessments of quality may be used. The assessment may be a measurement relating to the quality of the link or an estimate of quality of the link.

At step 164 the assessed quality of the link may be compared to a threshold quality level, (e.g., a threshold signal to noise ratio). If the assessed quality meets or exceeds the threshold quality level, then at step 166 communication via the wireless link at the unlicensed band proceeds (or continues). If the assessed quality does not meet the threshold level, then at step 168 communication along the wireless link is switched to a licensed band. Switching to a different frequency band (in any of the embodiments described herein) may include transmitting a command from a first device (e.g., backhaul point, uplink node, the MV user device, which may be a transformer bypass device, wireless modem) to the device with which the first device is communicating. The command may include information of the frequency to which the remote device should tune and continue or establish communications.

It is appreciated that when an unlicensed band does not meet the threshold quality, the communications alternatively may be switched to another unlicensed band. In some embodiments multiple unlicensed bands may be quality assessed before switching to a licensed frequency band. All unlicensed bands need not be quality assessed before switching to a licensed band. In various embodiments only an initial unlicensed band may be assessed before switching to a licensed band, or multiple unlicensed bands may be quality assessed before switching to a licensed band.

FIG. 5 is a flow chart of another example embodiment of the present invention. This method of establishing a wireless link also supports switching between licensed and unlicensed frequency channels at a given interface to maintain communications, and manage communication traffic. At step 170, a wireless communication ink 150, 152 is established using an unlicensed frequency band to communicate between a communication node (e.g., backhaul point or MV user device) of the hybrid communication sub-network 140 and a remote non-power line communication node (e.g., unlink node 144; premises modem 280). At step 172, the quality of the wireless link may be assessed. Step 172 is performed repeatedly, (e.g., periodically, aperiodically, randomly or at any suitable time delineation) as previously described with regard to step 162.

At step 174 the assessed quality may be compared to a threshold quality level (e.g., a threshold signal to noise ratio). If the assessed quality meets or exceeds the threshold quality level, then at step 176 communication via the wireless link proceed in the unlicensed band. If the assessed quality does not meet the threshold quality level, then at step 178 communication via the wireless link may be switched to a licensed frequency band (such as those listed herein or others).

Thereafter, at step 180 assessment of one or more unlicensed frequency bands may be performed repeatedly to identify an unlicensed band meeting or exceeding the quality threshold. The assessment may be performed periodically, aperiodically, randomly or at any other suitable time or frequency. At step 182 the assessed quality of the one or more unlicensed frequency bands may be compared to the quality threshold. If the assessed quality of the one or more unlicensed frequency band does not meet or exceed the quality threshold, then at step 184 communication may be maintained using the licensed frequency band. One will appreciate that communications along the licensed frequency band may continue throughout the quality assessment of unlicensed frequency band(s).

If at step 182 the quality of the assessed unlicensed frequency band is found to meet the threshold quality level, then at step 186, the wireless communication link 150,152 switches to that unlicensed frequency band for further communications. Thereafter, the unlicensed frequency band is assessed as described above at steps 172 and 174 to monitor its quality.

In the another embodiment, the device may first establish the communications link via a licensed band, which may be more reliable than an unlicensed band, and then assess the quality of one or more unlicensed bands until a suitable band is identified at which time communications may be switched to the unlicensed band.

Backhaul Point and Aggregation Point

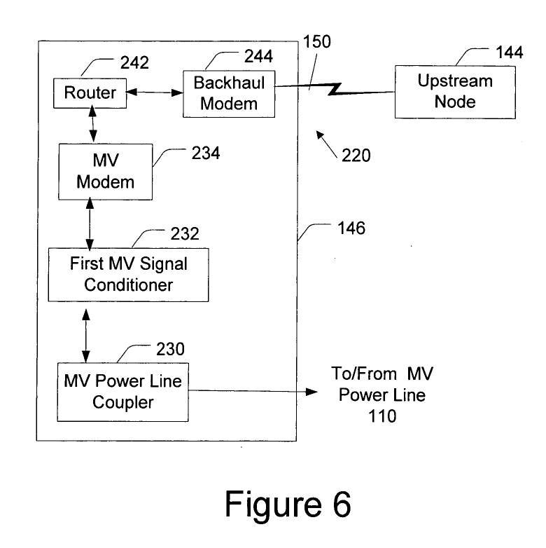

FIG. 6 illustrates one embodiment of a backhaul point 146 included in the hybrid communications sub-network 140. The backhaul point 146 is a communication node which is communications between the MV power line 110 and a non-power line medium. Only one backhaul point is shown for purposes of illustration. However, additional backhaul points also may be included. The backhaul point 146 serves as a backhaul interface 220 and gateway between the PLCS and a non-power line telecommunications network (e.g., IP network 142).

To couple data on and off the MV power lines 110, the backhaul point 146 includes an MV power line coupler 230, an MV signal conditioner 232 and an MV modem 234. The MV power line coupler 230 is used to prevent the medium voltage power conducted over the MV line 110 from being conducted to the backhaul point's circuitry, while allowing the communications signal to pass between the backhaul point 146 and the MV power line 110.

The MV power line coupler 230 may be coupled to each phase of the MV power line 110. In some embodiments, however, the coupler 230 may only be physically connected to one phase conductor of the MV power line 110. For example, when communicating along overhead MV power line conductors, data signals sometimes couple across the MV power line conductors. In other words, data signals transmitted on one MV phase conductor may be present on all of the MV phase conductors due to the data coupling between the phase conductors. As a result, the backhaul point 140 need not be physically connected to all three phase conductors of the MV power line cable. In embodiments where coupling between respective conductors is less likely, such as embodiments having underground MV power line cables, it may be preferable for the MV power line coupler 230 to have a separate coupler that is coupled to each of all of the available MV power line phase conductors.

The MV coupler 230 may include impedance translation circuitry, transient suppression circuitry, and a coupling device. The coupler 230 couples the data onto the MV power line 110 for a transmission. One example of such a coupler is described in U.S. appl. Ser. No. 10/348,164, Attorney Docket No. CRNT-0143, and entitled “Power Line Coupling Device and Method of Using the Same,” filed Jan. 21, 1403, which is hereby incorporated by reference in its entirety.

The MV signal conditioner 232 provides filtering (anti-alias, noise, and/or band pass filtering) and amplification. In addition, the MV signal conditioner 232 may provide frequency translation. For example, translation of the frequency is accomplished through the use of a local oscillator and a conversion mixer. Such method and other methods of frequency translation are well known in the art and, therefore, not described in detail.

The MV modem 234 provides data to and receives data from the router 236, and includes a modulator and demodulator. In addition, the MV modem 266 includes one or more functional sub-modules such as an ADC, DAC, memory, source encoder/decoder, error encoder/decoder, channel encoder/decoder, MAC controller, encryption module, and decryption module. These functional sub-modules are omitted in some embodiments, integrated into a modem integrated circuit (chip or chip set) in other embodiments, or integrated peripheral to a modem chip in still other embodiments. In one embodiment, the MV modem 234 is formed, at least in part, by part number INT51X1, which is an integrated power line transceiver circuit incorporating several of the identified submodules, and is manufactured by Intellon, Inc. of Ocala, Fla.

To perform MAC processing, the MV modem 234 adds a MAC header that includes the MAC address of the MV modem 234 as the source address and the MAC address of the destination node (and in particular, the MAC address of the MV modem of the destination node) as the destination MAC address. In addition, the MV modem 234 may also provide channel encoding, source encoding, error encoding, and encryption. For transmitting data onto the MV power lines 110, data is modulated and provided to the DAC to convert the digital data to an analog signal.

In this embodiment, MV communications employ a HomePlug standard (e.g., HomePlug 1.0 or AV). Other protocols may be implemented in other embodiments. In one embodiment a broadband frequency range such as 20-50 MHz, 2-50 MHz, or 30-50 MHz carrier frequency bands may be used. Any of several modulation techniques are used, such as CDMA, TDMA, FDM, and OFDM. In one example embodiment, the MV modem is substantially compliant with a HomePlug standard (e.g., HomePlug 1.0 or AV) and is an OFDM signal.

The backhaul point 146 may also include a router 242 which routes data along an appropriate path. The router 242 may be embodied as part of a controller and receives and sends data packets, matches data packets with specific messages and destinations, performs traffic control functions, performs usage tracking functions, authorizing functions, throughput control functions and similar routing-relating services. The router 242 may route data from the MV power lines 110 to a backhaul modem 244 and from the backhaul modem 244 onto the MV power lines 110. The router may also recognize commands addressed to the backhaul point 146 itself. A detail description of a router is provided below with respect to the bypass device 154.

The backhaul modem 244 provides communications with the upstream device and, therefore, with the IP network 142. In the embodiment illustrated, the backhaul modem 244 may establish and maintain a communication link with an upstream node 144 according to the flow charts or other embodiments described herein. Thus, the backhaul modem 244 may comprises a wireless modem, but in other embodiments may include any transceiver suited for communicating through the non-power line telecommunications medium that forms the backhaul link.

MV Access devices

The bypass devices 154 provide bi-directional communications between the MV power line and one or more customer premises via first and second data path. As will be evident to those skilled in the art, the two paths are logical paths. The paths may be separate physical electrical paths at certain functional blocks and may be the same physical path in other functional blocks. In other embodiments the physical paths are completely or substantially separated.

In the illustrated embodiment, the bypass device 154 may include a MV power line coupler 260, an MV signal conditioner 262, an MV modem 264, a router 266, an LV modem 268, an LV signal conditioner 270 and an LV power line coupler 272. The MV power line coupler 260, an MV signal conditioner 262, an MV modem 264 may be substantially the same as those components described for the backhaul point and therefore their description is not repeated here.

Subscribers accessing the service may use an LV power line link into a low voltage internal power line network 274 using a power line modem 276. In such example, data is moved from the MV power line 110 around the distribution transformer 112 by the bypass device 154 onto the LV power lines 114. The LV power lines 114 extend to customer premises 148 and connect to a low voltage internal power line network 274, (e.g., such as through a circuit breaker panel). The power line modem 276 links into the premises power network 274 to receive from and transmit data to the bypass device 154.

In other embodiments, other communication links may be supported, such as an LV power line link, a fiber optic link, a telephone line link, an Ethernet link, or a twisted pair link. For any of the fiber optic interface, telephone line interface, Ethernet interface, twisted pair interface and wireless interface, an appropriate modem is included in or in the vicinity of the bypass device 154 and at the customer premises 148. In one example embodiment, at least one subscriber accesses the network via a wireless link. Accordingly, a wireless modem 278 may be included as part of or located near and coupled to the bypass device 154, and another wireless modem 280 included at the customer premises 148. The wireless modems described herein may be configured to communicate using one or more frequency channels in one or more licensed or unlicensed frequency bands. Alternately, the bypass device 154 (and backhaul point described above and other nodes having communicating wirelessly) may include a first wireless modem for unlicensed band wireless communications and a second modem for licensed band wireless communications.

The router 266 may be embodied as part of a controller and performs routing functions. For example, router 266 may perform routing functions using layer 3 data (e.g., IP addresses), layer 2 data (e.g., MAC addresses), or a combination of layer 2 and layer 3 data (e.g., a combination of MAC and IP addresses). In addition to routing, the controller performs other functions for controlling the operation of the bypass device 154/284 functional components. In other embodiments, the bypass device 154/284 performs layer 2 bridging.

In one embodiment the router 266 uses a table (e.g., a routing table) and programmed routing rules stored in memory to determine the next destination of a data packet. The table is a collection of information and includes information relating to which interface (e.g., medium voltage or low voltage) leads to particular groups of addresses (such as the addresses of the user devices connected to the customer LV power lines), priorities for connections to be used, and rules for handling both routine and special cases of traffic (such as voice packets and/or control packets).

The router 266 detects routing information, such as the destination address (e.g., the destination IP address) and/or other packet information (such as information identifying the packet as voice data), and matches that routing information with rules (e.g., address rules) in the table. The rules may indicate that packets in a particular group of addresses should be transmitted in a specific direction such as through the LV power line 114 (e.g., if the packet was received from the MV power line and the destination IP address corresponds to a user device connected to the LV power line), repeated on the MV line (e.g., if the bypass device 230 is acting as a repeater), or be ignored (e.g., if the address does not correspond to a user device connected to the LV power line or to the bypass device 230 itself).

As an example, the table may include information such as the IP addresses (and potentially the MAC addresses) of the user devices 350, the MAC addresses of the wireless modems 278, the premises modems 280, the power line modems 276, the MV modem 264, the LV modem 268 and other modems communicating with the bypass device 154. Based on the destination IP address of the packet (e.g., an IP address), the router 266 passes the packet to the MV modem 264 for transmission on the MV power line 110, to the wireless modem 278 for transmission via the wireless link, or to a power line modem 276 via the LV modem 268 and LV power lines 114. Alternately, if the IP destination address of the packet matches the IP address of the bypass device 154 the bypass device 154 may process the packet as a request for data.

With regard to the bypass device 154, the LV power line coupler 272, LV signal conditioner 270 and LV modem 268 are now described. The LV power line coupler 272 couples data to and from the LV power line 114. The coupler 272 also can couple power from the LV power line 114 to power at least a portion of the bypass device 154. In the United States, the LV power line 114 typically includes a neutral conductor and two conductors carrying current (“hot” conductors). In the United States, the two hot conductors typically carry about 120V alternating current (AC) at a frequency of 60 Hz and are 180 degrees out of phase with each other.

In one embodiment the LV coupler 272 is an inductive coupler, such as a toroidal coupling transformer, or is a capacitive coupler. In another embodiment, the conductors from the bypass device 154 may simply have leads connected to the two LV hot conductors. The signals entering the bypass device 154 are processed with conventional transient protection circuitry, which is well-known to those skilled in the art. The data signals “ride on” (i.e., are additive of) the low frequency power signal the 120V 60 Hz voltage signal. Consequently, it is desirable to remove the low frequency power signal, but to keep the data signals for processing. This is accomplished by the voltage translation circuitry. The voltage translation circuitry includes a high pass filter to remove the low frequency power signal and may also (or instead) include other conventional voltage translation circuitry.

The data signals also are processed with impedance translation circuitry, which is well-known in the art. In this embodiment, it is desirable to substantially match the impedance of the LV power line 114. One method of matching the impedance of the LV power line 114 is to separately terminate the bypass device LV power line conductors through a termination resistor to ground. The value of the termination resistor is selected to match the characteristic impedance of the LV power line 114.

The bypass device 154 in some embodiments includes a battery backup for operating the bypass device 154 during power outages. Thus, a backup power system (which may include a battery) may allow the device 154 to detect a power outage and communicate information relating to the outage to the utility company. The backup power system also allows the bypass device 154 to communicate certain data packets during a power outage. For example, during an outage, the bypass device 154 can be programmed to communicate all voice data or only emergency voice transmissions (e.g., phone calls dialed to 911), which may require the controller to inspect the destination telephone numbers of one or more packets to determine the destination of the telephone call when there is a power outage.

The LV signal conditioner 270 conditions data signals using filtering, automatic gain control, and other signal processing to compensate for the characteristics of the LV power line 114. For example, the data signal may be filtered into different bands and processed.

One terminal of the LV signal conditioner 270 Is coupled to the LV power coupler 272, and another terminal is coupled to the LV modem 268. The LV modem 268 includes a modulator and a demodulator. The LV modem 268 also includes one or more additional functional sub-modules such as an Analog-to-Digital Converter (ADC), Digital-to-Analog Converter (DAC), a memory, source encoder/decoder, error encoder/decoder, channel encoder/decoder, MAC (Media Access Control) controller, encryption module, and decryption module. In various embodiments, one or more functional sub-modules are omitted, integrated into a modem integrated circuit (chip or chip set), or integrated peripherally to a modem chip. In the present example embodiment, the LV modem 268 is formed, at least in part, by part number INT51X1, which is an integrated power line transceiver circuit incorporating most of the above-identified sub-modules, and which is manufactured by Intellon, Inc. of Ocala, Fla.

The LV modem 268 passes data from the LV signal conditioner to the router 266, and passes data received from the router 266 to the LV signal conditioner 270. The LV modem 268 provides encryption and decryption, source coding and decoding, error coding and decoding, channel coding and decoding, and media access control (MAC) all of which are known in the art and, therefore, not explained in detail here.

With respect to MAC processing, however, the LV modem 268 may examine information in the packet to determine whether the packet should be ignored or passed to the router 266. For example, the LV modem 268 may compare the destination MAC address of the packet with the MAC address of the LV modem 268 (which is stored in the memory of the LV modem 268). If there is a match, the LV modem 268 removes the MAC header of the packet and passes the packet to the router 266. If there is not a match, the packet may be ignored.

User Devices

A variety of user devices 350 can access the hybrid communication sub-network 140 from a subscriber's premises 148. Examples of user devices 350 that may connect to the sub-network 140 include Voice-over IP endpoints, game systems, digital cable boxes, computers 352, routers 354, local area networks 356, power meters, security systems, alarm systems (e.g., fire, smoke, carbon dioxide, etc.), stereo systems, televisions, and fax machines.

LV Power Line Link

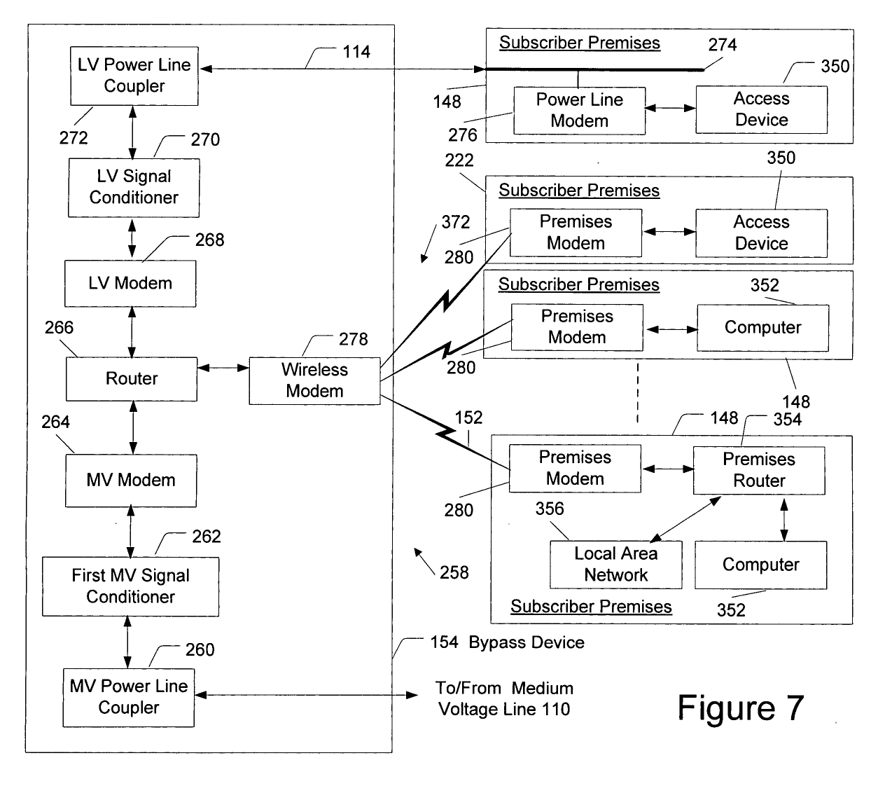

Referring to FIG. 7, for subscribers accessing the network through an LV power line communication link, one or more power line modems (PLM) 276 interface between the user devices 350 and the low voltage power line network 274. A given PLM 276 may provide network access to one or more user devices 350. For data received from the bypass device 154, the PLM 276 demodulates the data and then may forward the data to the targeted user device 350. For data input from a connected user device 350, the PLM 276 formats, modulates, and transmits the data in a signal suitable for transmission along the low voltage power line 114. Various data formats and modulation schemes may be used. For example, the HomePlug® Alliance has developed a standard (HomePlug 1.0) for communicating over low voltage power lines. For convenience, the system will be described using the HomePlug standard (which may include HomePlug 1.0 or HomePlug AV), but other standards and schemes may be used for communication along the low voltage power line. Because multiple PLMs 274 may be interconnected by low voltage lines, the line is shared and data transmission is managed to avoid transmission collisions.

The premises power line network 274 includes various electrical circuits at the customer's premises 148 which distribute power and data signals within the customer premises. A power customer draws power on demand by plugging a device into a power outlet. In a similar manner, a hybrid sub-network 140 subscriber plugs the power line modem 276 into a power outlet to form a digitally communication path to and from user devices 350. The communication signals are carried over the residential power wiring.

The PLM 276 can have a variety of interfaces for customer data appliances. For example, a PLM 276 can include a RJ-11 Plain Old Telephone Service (POTS) connector, an RS-232 connector, a USB connector, a 10 Base-T connector, RJ-45 connector, and the like. In this manner, a customer can connect a variety of user devices 350 to the PLCS. Further, multiple PLMs 276 can be plugged into power outlets throughout the customer premises, with each PLM 276 communicating over the same wiring internal to the customer premises.

The PLM 276 can be connected to (or integrated into) any device capable of supplying data for transmission (or for receiving such data) including, but not limited to a computer, a telephone, a telephone answering machine, a fax, a digital cable box (e.g., for processing digital audio and video, which may then be supplied to a conventional television and for transmitting requests for video programming), a video game, a stereo, a videophone, a television (which may be a digital television), a video recording device, a home network device, a utility meter, or other device. The functions of the PLM 276 may be integrated into a smart utility meter such as a gas meter, electric meter, water meter, or other utility meter to provide automated meter reading (AMR).

Power Line Server

In some embodiments the hybrid communications sub-network 140 also includes a power line server (PLS) that is a computer system with memory for storing a database of information about the sub-network 140. The PLS includes a network element manager (NEM) that monitors and controls the sub-network 140. The PLS allows network operations personnel to provision users and network equipment, manage customer data, and monitor system status, performance and usage. The PLS may reside at a remote operations center to oversee a group of communication devices via the IP network 142.

The PLS provides an IP network identity to the network devices (e.g., backhaul modem 244, MV modem 234, 264, LV modem 268, routers 242, 266, wireless modems 278, premises wireless modems 280, power line modems 276, and LV and MV repeaters) by assigning each device an IP address and storing the IP address and other device identifying information (e.g., the device's location, address, serial number, etc.) in its memory. In addition, the PLS may approve or deny user devices authorization requests, command status reports and measurements from the bypass devices, repeaters, and backhaul points, and provide application software upgrades to the communication devices (e.g., bypass devices, backhaul points, repeaters, and other devices).

By collecting electric power distribution information and interfacing with utilities' back-end computer systems, the PLS provides enhanced distribution services such as automated meter reading, outage detection, load balancing, distribution automation, Volt/Volt-Amp Reactance (Volt/VAr) management, and other similar functions.

The PLS also may be connected to one or more back haul points 146, and/or core routers 242, 266 directly or through the IP network 142 and therefore can communicate with any of the bypass devices 154, routers 242, 266, user devices 350, backhaul points 146, and other network elements. The PLS may also transmit subscriber information, such as whether a particular data service is enabled for a user (e.g., voice), the level of service for each data service for a user (e.g., for those data services having more than one level of service), address information (e.g., IP address and/or media access control (MAC) addresses for devices) of the subscribers, and other information.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended

Those skilled in the art, having the benefit of the teachings of this specification, may affect numerous modifications thereto and changes may be made without departing from the scope and spirit of the invention.

What is claimed is:

1. A method of using a communications device, comprising:
establishing a first wireless communication link using an unlicensed frequency band;
assessing the quality of the first wireless communication link to determine whether the quality is below a threshold quality; and
if the assessed quality is determined to be below the threshold quality, establishing a second wireless communication link using a licensed frequency band.

2. The method of claim 1, further comprising:
transmitting a command over the first wireless communication link, and wherein said command is a command to communicate via the licensed frequency bad.

3. The method of claim 1, further comprising:
receiving data over the first wireless communication link; and
transmitting said received data over a medium voltage power line.

4. The method of claim 1, further comprising:
repeating said assessing to monitor the quality of the first wireless communication link.

5. The method of claim 1, further comprising:
receiving data over the second wireless communication link; and
transmitting said received data over a medium voltage power line.

6. A method of providing wireless communication, comprising:
establishing a first power line communication link;
establishing a first wireless communication link with a first frequency band;
communicating data over the first power line communication link and the first wireless communication link;
monitoring the quality of the wireless communication link to determine whether the quality is below a threshold quality; and
if the monitored quality is determined to be below the threshold quality, establishing a wireless communication within a second frequency band.

7. The method of claim 6, wherein said first frequency band comprises an unlicensed frequency band and said second frequency band comprises a licensed frequency band.

8. The method of claim 7, further comprising after establishing wireless communication within the second frequency band:
monitoring the first frequency band to determine whether the first frequency band satisfies a set of predetermined performance parameters; and
when the monitored first frequency band is determined to satisfy the set, establishing wireless communications within the monitored first frequency band.

9. A method of communication in a hybrid communication system having a backhaul point and an endpoint communication interface, comprising:
establishing a first power line communication link between a first and second medium voltage access device;
maintaining a first wireless communication link between the first medium voltage access device and a first wireless node;
wherein said maintaining comprises:
establishing the first wireless communication within an unlicensed frequency band;
monitoring the quality of the wireless communication;
determining whether the quality is below a threshold quality; and
establishing the first wireless communication link within a licensed frequency band if the quality is determined to be below the threshold quality.

10. The method of claim 9, in which said maintaining comprises:
wherein the between the first medium voltage access device comprises a backhaul point.

11. The method of claim 10, further comprising:
receiving a first communication at the backhaul point over the first wireless communication link;
routing the first communication over the power line communication link to the second medium voltage access device; and
transmitting the first communication to a user device.

12. The method of claim 11, wherein said transmitting comprises:
receiving the first communication from the power line communication link; and
transmitting the first communication over a second wireless communication link to wireless modem communicatively coupled to the user device.

13. The method of claim 12, wherein said unlicensed frequency band is a first unlicensed frequency band, wherein the licensed frequency band is a first licensed frequency band, and further comprising:
establishing the second wireless communication link within a second unlicensed frequency band;
monitoring the quality of the second wireless communication link;
determining whether the monitored quality of the second wireless communication link is below a threshold quality; and
establishing the second wireless communication link within a second licensed frequency band when the monitored quality is determined to be below the threshold quality.

14. The method of claim 13 wherein the first unlicensed frequency band is the same as the second unlicensed frequency band.

15. The method of claim 13 wherein the first licensed frequency band is the same as the second licensed frequency band.

16. The method of claim 9, wherein the first medium voltage access device comprises a bypass device.

17. The method of claim 16, further comprising:
receiving a first communication from a user device at the bypass device over the wireless communication link;
sending the first communication over the first power line communication link to the second MV access device; and
transmitting the first communication to an uplink node from the second MV access device.

18. The method of claim 17, wherein said transmitting comprises:
receiving the first communication from the power line communication link; and
transmitting the first communication over a second wireless link to the uplink node.

19. The method of claim 9, wherein the steps are performed by a bypass device.

20. The method of claim 9, wherein the first MV access device comprises a bypass device communicatively coupled to a plurality of user devices.
